(19) United States
(12) Patent Application Publication
(10) Pub. No.: US 2026/0287977 A1
(43) Pub. Date: Sep. 24, 2026

(54) SYSTEMS AND METHODS FOR PRIVACY-PRESERVING MOBILE CAMERAS

(71) Applicant: Corephotonics Ltd., Tel Aviv (IL)

(72) Inventor: Ruthy Katz, Tel Aviv (IL)

(21) Appl. No.: 19/473,303

(22) PCT Filed: Apr. 8, 2024
(86) PCT No.: PCT/IB2024/053440

§ 371 Date: Oct. 7, 2025

Related U.S. Application Data
(60) Provisional application No. 63/495,139, filed on Apr. 10, 2023.
(60) Provisional application No. 63/582,247, filed on Sep. 13, 2023.

(51) Int. Cl. G03B 11/04; G02B 5/02; G02B 5/18; G02B 7/00; G02B 7/10; G03B 30/00; H04M 1/02; H04N 23/60

(52) U.S. Cl. CPC G03B 11/04; G02B 5/0294; G02B 5/1871; G02B 7/006; G03B 30/00; H04M 1/0264; H04N 23/64; G02B 7/10

(57) ABSTRACT

Mobile devices comprising a privacy camera configured and operational to capture privacy-preserving image data of a scene, wherein the privacy camera is a pop-out camera or a regular camera covered with an optical element or a coded aperture mask, wherein the mobile device is configured to transfer the captured privacy-preserving image data to a communication network, and wherein the privacy of a person present in the scene is not violated by transferring the privacy-preserving image data to the communication network. In some examples, the communication network is the Internet.

### CROSS REFERENCE TO RELATED APPLICATIONS

This is a 371 application from international patent application PCT/IB2024/053440 filed Apr. 8, 2024, which claims the benefit of U.S. provisional patent applications No. 63/495,139 filed Apr. 10, 2023 and 63/582,247 filed Sep. 13, 2023, which are incorporated herein by reference in their entirety

### FIELD

Examples disclosed herein relate in general to privacy-preserving photography with a mobile device, and in particular to systems and methods for generating and sharing privacy-preserving image data with mobile devices.

### BACKGROUND

Mobile handheld electronic devices (“mobile devices” in the following) such as smartphones, tablets, headsets, smartwatches etc., which are configured to capture images (or video streams of images) and to share these images via communication networks such as (but not limited to) the Internet are known. Especially, sharing of video streams of images between such mobile devices is gaining ever higher popularity.

FIG. 1A shows a known method 100 for generating and transferring an image or a video stream of images by means of a mobile device. For simplicity, in the following we refer to (single) images only, but if not explicitly stated otherwise, it shall also include (or refer to) video streams of images.
In a step 102, a user or a program activates a camera included in the mobile device. In general, the program activating the camera is instructed to do so by the user. In other and sometimes undesired scenarios, the program activating the camera is instructed by a third person or a third party, without (or even against) an intention of the user.
In a step 104, a camera captures a scene in high resolution, i.e. the camera generates high-resolution image data. “High resolution” means here a spatial (or pixel) resolution that allows capture of the scene in large detail. In particular, “high resolution” means here that the spatial resolution is sufficiently high to analyse details of the captured scene that may violate the privacy of a person. A high resolution may correspond to a pixel resolution of about 0.5 megapixel (“MP”) or more. In some examples, the person may be an owner of the mobile device (referred to henceforth as “owner”) who is intentionally capturing images of herself or himself. In other examples, the person may not be an owner of the mobile device, but a person who is unintentionally captured by the mobile device, e.g. by coincidentally entering a background captured by the camera. Such a person will be referred to henceforth as “bystander”.
In an optional step 106, the high-resolution image data may be processed.
In a step 108, the high-resolution image data may be transferred to a communication network such as (but not limited to) the Internet (e.g. to a cloud server). To clarify, herein we refer to any technology as performing “transfer to the Internet” which (1) allows to share information between electronic devices such as mobile devices and (2) does not require a physical proximity of the involved mobile devices. In particular, the transfer must not necessarily be performed via specific protocols or standards generally used in “the Internet”. For example, sharing images via a messenger application or a social media application is referred to as transfer to the Internet, sharing images via Bluetooth is not referred to as transfer to the Internet. In general, the high-resolution image data is shared with a third person or with a group of third persons, referred to in the following as “high-resolution image data sharing”. The transfer of high-resolution image data to the Internet may be performed intentionally by the owner, or it may be performed unintentionally, e.g. by mistake, or it may be performed against the intention (or will) of the owner, e.g. in case of Internet fraud or a hacker attack. Therefore and undesirably, the privacy of a person may be violated. The privacy violation may e.g. be caused by the fact that a third person gains knowledge on the appearance or on an action of the owner or a bystander by analysing the transferred high-resolution image data.

FIG. 1B shows a known mobile device 150 having a rear surface 152 which is in general pointed towards a scene. Mobile device 150 may as well include a front surface (not shown) oriented opposite to rear surface 152, which is in general pointed towards a user and includes a screen (not shown). Rear surface 152 includes a known pop-out (P-O) camera 154 having a pop-out camera field-of-view (FOV). Pop-out cameras are for example disclosed in international patent applications PCT/IB2020/058697 and in PCT/IB2022/050575, which are incorporated herein by reference in their entirety. P-O camera 154 is in a “P-O state” or “active state”, where P-O camera 154 is operational to image (or capture) a scene in high resolution. We note that in the P-O state, P-O camera 154 protrudes (or “pops out”) out of rear surface 152, as shown by arrow 156. Mobile device 150 also includes another camera 158, which may be a Wide camera or an Ultra-Wide (UW) camera having a Wide or UW camera FOV (larger than the P-O camera FOV), or it may be a Tele camera having a Tele camera FOV (smaller than the P-O camera FOV).

FIG. 1C exemplarily illustrates a functionality of P-O camera 154 in the P-O state. Dot (or “point”) 160 illustrates a circular object having a diameter (“D_{REAL}”) as present in a scene. Dot 162 represents a high-resolution image of dot 160 as captured by P-O camera 154 in the P-O state. Dot 162 has a diameter (“D_{P-O}”). It is visible that characteristics such as size, shape etc. of (real) dot 160 are reproduced by (imaged) dot 162 in great detail, in particular D_{REAL}=D_{P-O}.

FIG. 1D shows known mobile device 150 of FIG. 1B with P-O camera 154 in a “collapsed state” or “inactive state”, where P-O camera 154 is not operational to image a scene in high image resolution. We note that in the collapsed state, P-O camera 154 does not protrude (or does significantly less protrude) out of rear surface 152, as shown at position 164.

FIG. 1E exemplarily illustrates a functionality of P-O camera 154 in a collapsed state. Dot 166 represents a high-resolution image of dot 160 as captured by P-O camera 154 in the collapsed state. Dot 166 has a diameter (“D_{C}”, “C” for “collapsed”). It is visible that characteristics such as size, shape, etc. of (real) dot 160 are only partly reproduced by (imaged) dot 166. In particular, D_{REAL}<D_{C}, i.e. dot 166 is blurred.

There is need and it would be beneficial to have a mobile camera that prevents violating the privacy of a person (be it owner or bystander).

### SUMMARY

In various examples, there are provided mobile devices comprising a privacy camera configured and operational to capture privacy-preserving image data of a scene, wherein the privacy camera is a pop-out camera, wherein the mobile device is configured to transfer the captured privacy-preserving image data to a communication network, and wherein the privacy of a person present in the scene is not violated by transferring the privacy-preserving image data to the communication network.

In some examples, the communication network is the Internet.

In some examples, a privacy camera is configured and operational to capture privacy-preserving image data of a scene with the pop-out camera in a collapsed state.

In some examples, a mobile device has a rear surface and a front surface located opposite to the rear surface, the front surface includes a screen, and the privacy camera is included in the rear surface and has a privacy-preserving camera state in which the pop-out camera protrudes less from the rear surface than in a non-privacy preserving camera state.

In some examples, a privacy camera includes a privacy actuator operational to switch the privacy camera between a privacy-preserving camera state and one or more additional non-privacy-preserving camera states.

In some examples, the pop-out camera includes an optical component, the one or more additional camera states include a collapsed state and a pop-out state, and the privacy actuator is configured to move the optical component to switch the privacy camera between the privacy-preserving camera state, the collapsed state and a pop-out state.

In some examples, a first movement of the optical component to switch the privacy camera between the collapsed state and the privacy-preserving camera state is shorter than a second movement of the optical component to switch the privacy camera between the collapsed state and the pop-out state.

In some examples, a mobile device has a rear surface and a front surface located opposite to the rear surface, the front surface includes a screen, the privacy camera is included in the rear surface, and in the privacy-preserving camera state, the pop-out camera protrudes less from the rear surface than in the pop-out state.

In some examples, a privacy camera is a multi-state zoom camera having a zoom lens with two or more zoom states, wherein each zoom state corresponds to a respective zoom state lens position, and wherein the zoom lens operates as a privacy camera when not operated at a respective zoom state lens position.

In some examples, a mobile device is configured to extract particular scene information from the privacy-preserving image data. In some examples, the particular scene information is an action or a gesture or a posture of a person. In some examples, the mobile device is further configured to create an avatar, and the avatar is shown performing the action or the gesture or the posture of the person.

In some examples, a privacy camera includes an adaptive aperture (AA) used to define a degree of privacy. In some examples, the pop-out camera has a f number f/#, the f/# depends on the AA, and a minimum f/#_{Min} is in the range of f/1.0-f/5. In some examples, the pop-out camera has a f number f/#, the f/#depends on the AA, and a maximum f/#_{Max} is in the range of f/1.2-f/50. In some examples, the pop-out camera is a Wide camera with a minimum f/#_{Min} in the range of f/1.5 to f/3 and a maximum f/#_{Max} in the range of f/2 to f/16. In some examples, the pop-out camera is a Tele camera with a f/#_{Min} in the range of f/1.8 to f/5 and a f/#_{Max} in the range of f/2.5 to f/16.

In some examples, ae mobile device includes at least one additional camera, and image data captured by the at least one additional camera is used to define the AA.

In various examples, there are provided mobile devices comprising a privacy camera configured and operational to capture privacy-preserving image data of a scene, wherein the mobile device is configured to transfer the captured privacy-preserving image data to a communication network, wherein the privacy camera is a regular camera covered with an optical element or a coded aperture mask, and wherein the privacy of a person present in the scene is not violated by transferring the privacy-preserving image data to communication network.

In some examples, a privacy camera includes a privacy actuator operational to switch the privacy camera between a privacy-preserving state and a non-privacy preserving camera state.

In some examples, a mobile device includes a manual physical shutter operational to switch the privacy camera between a privacy-preserving state and a non-privacy preserving camera state.

In some examples, a mobile device is configured to extract particular scene information from the privacy-preserving image data. In some examples, the particular scene information is an action or a gesture or a posture of a person.

In some examples, a mobile device is further configured to create an avatar, and the avatar is shown performing the action or the gesture or the posture of the person.

In some examples, a privacy camera includes an AA used to define a degree of privacy. In some examples, the privacy camera has a variable f number f/#, the variation of f/#depends on the AA, and a minimum f/#Min is in the range of f/1.0-f/5 and/or a maximum f/#_{Max} is in the range of f/1.2-f/50.

In some examples, the AA is controlled by a user. In some examples, the AA is controlled by an algorithm.

In some examples, a privacy camera has an effective focal length in the range of 2.5 mm to 50 mm. In some examples, the privacy camera has an effective focal length in the range of 2.5 mm to 15 mm.

In some examples, the mobile device is a smartphone. In some examples, the mobile device is a tablet. In some examples, the mobile device is a laptop computer.

### BRIEF DESCRIPTION OF THE DRAWINGS

Non-limiting examples of examples disclosed herein are described below with reference to figures attached hereto that are listed following this paragraph. The drawings and descriptions are meant to illuminate and clarify examples disclosed herein and should not be considered limiting in any way. Like elements in different drawings may be indicated by like numerals. Elements in the drawings are not necessarily drawn to scale. In the drawings:

FIG. 1A shows a method for generating and transferring image data as known in the art;

FIG. 1B shows a mobile device including a P-O camera in a P-O state as known in the art;

FIG. 1C shows a real object along an object as captured by the mobile device shown in FIG. 1B;

FIG. 1D shows the mobile device of FIG. 1B including a P-O camera in a collapsed state;

FIG. 1E shows a real object along an object as captured by the mobile device shown in FIG. 1D;

FIG. 2A shows an example of a mobile device including a privacy camera as disclosed herein;

FIG. 2B shows a real object along an object as captured by the mobile device including a privacy camera shown in FIG. 2A;

FIG. 2C shows another example of a mobile device including a privacy camera as disclosed herein;

FIG. 2D shows a real object along an object as captured by the another mobile device including a privacy camera shown in FIG. 2C;

FIG. 3A shows an example of a method for generating and transferring privacy-preserving image data as disclosed herein;

FIG. 3B shows another example of a method for generating and transferring privacy-preserving image data as disclosed herein;

FIG. 4 shows schematically an example of a mobile device configured to generate and transfer privacy-preserving image data disclosed herein.

FIG. 5A shows a camera operational as privacy camera as disclosed herein in a first camera state;

FIG. 5B shows the camera of FIG. 5A in a second camera state;

FIG. 5C shows another camera operational as privacy camera as disclosed herein in a first camera state;

FIG. 5D shows the camera of FIG. 5C in a second camera state.

### DETAILED DESCRIPTION

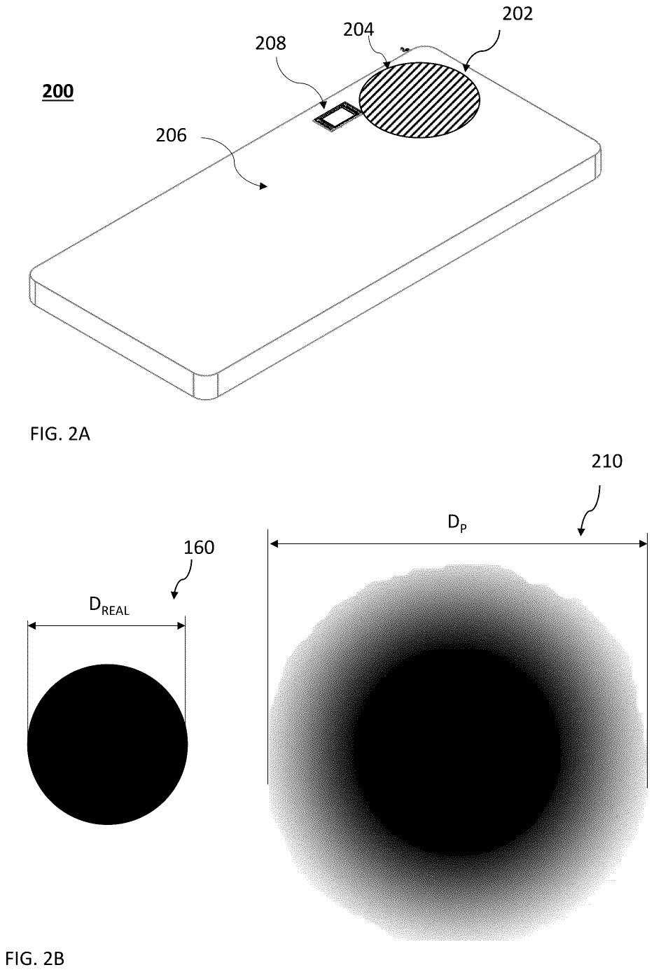

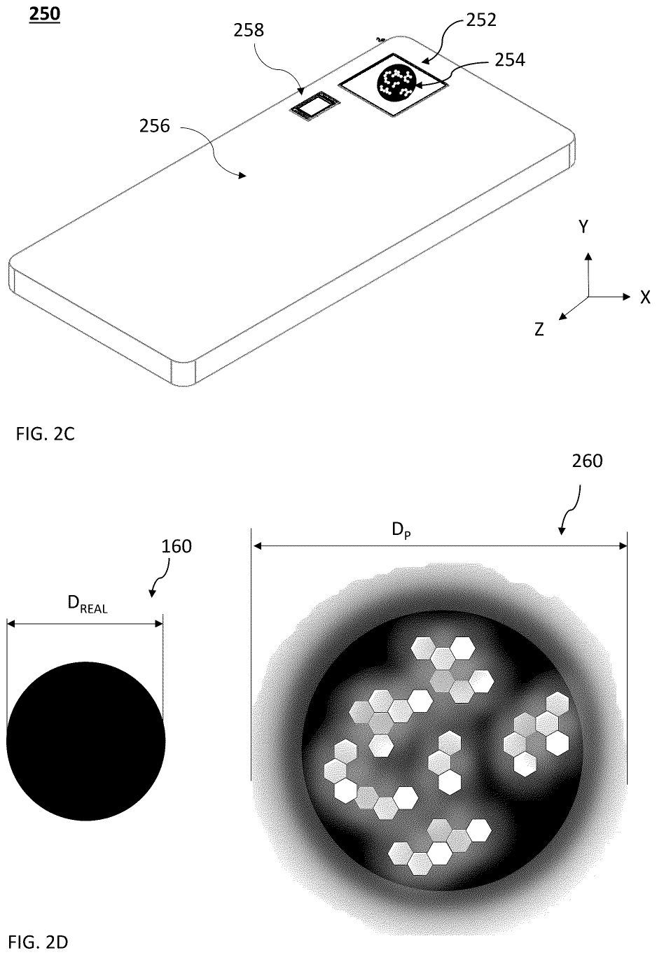

FIG. 2A shows an example of a mobile device numbered 200 that includes a privacy-preserving camera (or simply “privacy camera”) numbered 202 disclosed herein. For preserving privacy, an aperture of privacy camera 202 may be covered with a suitable optical element 204. “Suitable” means here that optical element 204 is configured to disturb (or “encrypt”) image information before it reaches privacy camera 202. The encryption is done so that it prevents capturing high-resolution image data which may violate the privacy of a person. Optical element 204 may e.g. be an optical diffuser as known in the art, a grating such as a phase grating as known in the art, etc. Due to optical element 204, privacy camera 202 is operational to capture privacy-preserving image data (or in short “privacy-preserving data”), i.e. image data which does not violate the privacy of a person. Privacy camera 202 is included in a rear surface 206 of mobile device 200. Mobile device 200 may also include a second camera 208. A privacy camera configured to perform methods disclosed herein may have an effective focal length (“EFL”) in the range of 2.5 mm to 50 mm. Preferably, EFL is in the range of 2.5 mm to 15 mm.

In some examples, an optical element such as optical element 204 may be used in a laptop (or “notebook”). We note that often, laptops already include a manual physical shutter for closing an aperture of a camera included in the laptop. It may be relatively simple to add an optical element such as optical element 204 to such a manual physical shutter, so that a user can select to close the aperture of a camera included in the laptop, or to cover the aperture of a camera included in the laptop with an optical element that is operational to turn the camera into a privacy camera. Also in mobile devices, an optical element may be implemented as a manual physical shutter.

FIG. 2B illustrates exemplarily a functionality of privacy camera 202. Dot 210 represents an image of dot 160 as captured by privacy camera 202. Dot 210 has a diameter (“D_{P}”, “P” for “privacy”). It is visible that characteristics such as size, shape etc. of (real) dot 160 are only partly reproduced by (imaged) dot 210. In particular, D_{REAL}<D_{P}, i.e. dot 210 is blurred.

FIG. 2C shows another example of a mobile device numbered 250 that includes another privacy camera numbered 252 disclosed herein. For preserving privacy, an aperture of privacy camera 252 may be covered with a “coded aperture” mask 254 as known in the art. Coded-aperture masks are grids, gratings, etc. of materials that have different opacity. Often, parts of a coded aperture block light (i.e. are opaque), while other parts do not block light (i.e. are transparent). In other examples, light may be blocked only partially. In yet other examples, light may not be blocked but manipulated otherwise, for example by a phase grating, as known in the art. Coded aperture mask 254 is configured to disturb image information before it reaches privacy camera 202, so that coded aperture mask 254 prevents capturing high-resolution image data which may violate the privacy of a person. Due to coded aperture mask 254, privacy camera 252 is operational to capture privacy-preserving image data. Privacy camera 252 is included in a rear surface 256 of mobile device 250. Mobile device 250 may also include a second camera 258.

FIG. 2D illustrates exemplarily a functionality of privacy camera 252. Dot 260 represents an image of dot 160 as captured by privacy camera 202. Dot 260 has a diameter (“D_{P}”). It is visible that characteristics such as size, shape etc. of (real) dot 160 are only partly reproduced by dot 260. In particular, D_{REAL}<D_{P}, i.e. dot 260 is blurred. In addition, coded aperture mask 254 imposes a coding pattern as known in the art.

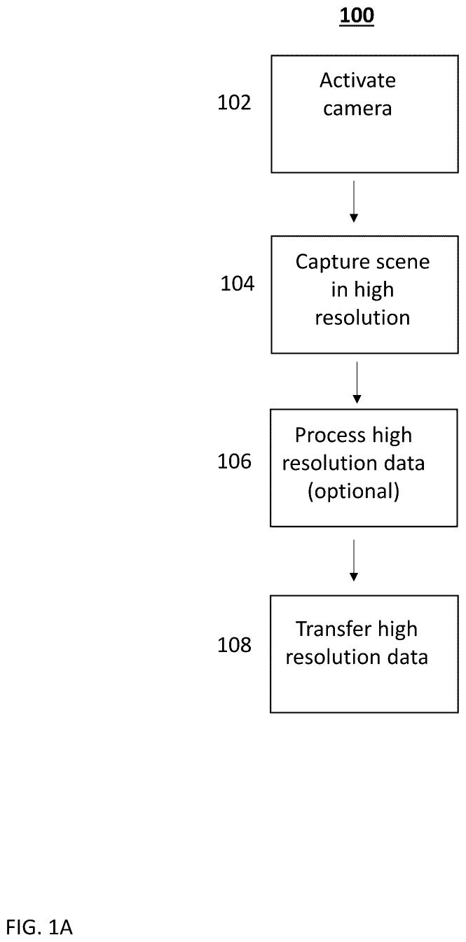

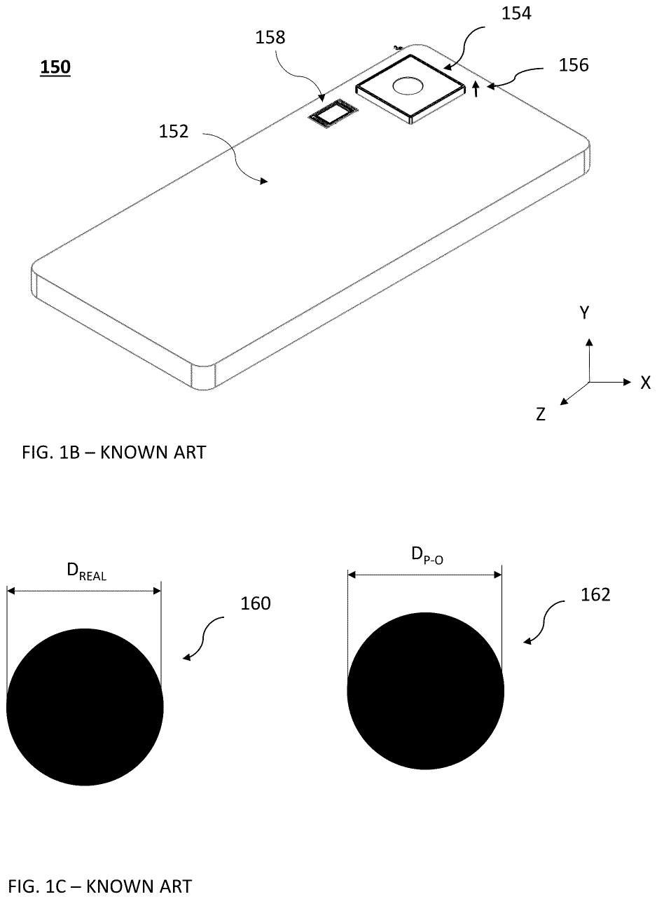

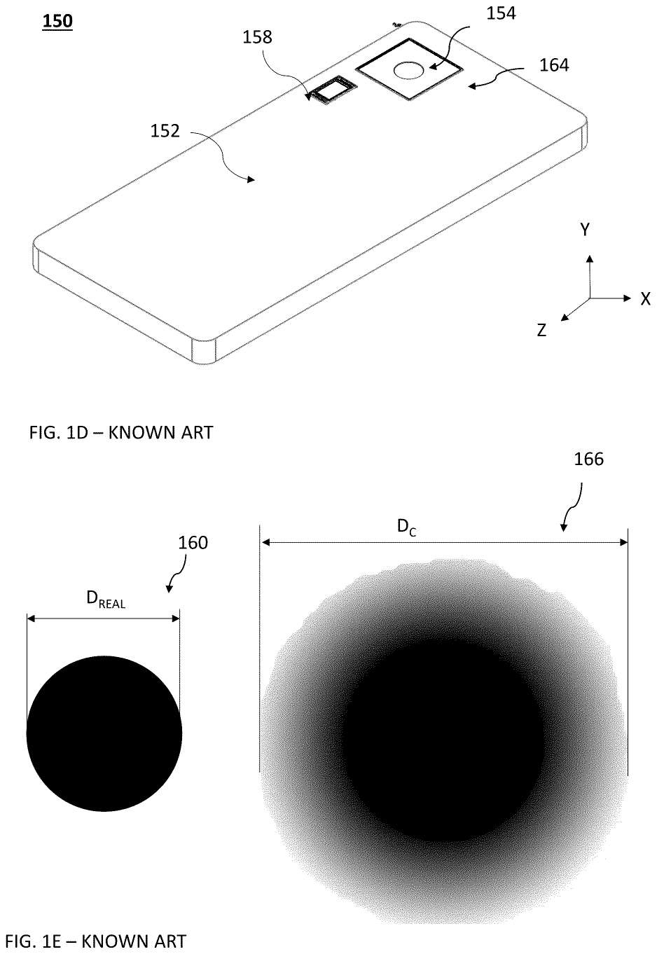

In other examples, privacy according to a method disclosed herein may be provided by using a P-O camera in a collapsed state, such as shown in FIG. 1D. The collapsed state “blurs” parts of an image in the same or similar way as the optical element above. As of the difference in protrusion of a P-O camera in the pop-out state, in the collapsed state or in an intermediate state, via the protrusion a P-O camera provides a visual indication of a “privacy mode”. Any image taken with the P-O camera in this state will provide privacy.

In some examples, optical elements of a privacy camera may be designed so that they fulfil the following two conditions:
1. Sufficiently disturb image information before it reaches an image sensor, e.g. by blurring. “Sufficiently” means here that an image information is disturbed so that capturing high-resolution image data (which may violate privacy) is not possible.
2. Retain sufficient image information to be able to interpret particular aspects or actions happening in a scene.

In other words, optical elements of a privacy camera may be designed so that they preserve a person's privacy, but still allow to extract particular scene information which is considered (or classified) as not violating a person's privacy. In the following, we refer to the two conditions as “privacy-camera conditions”. The particular scene information may include actions and gestures that a person performs. A relevant optical element may e.g. be a lens included in P-O camera 154, or an optical element such as optical element 204 included in privacy camera 202, or a coded aperture mask such as coded aperture mask 254 included in privacy camera 252.

In some examples, optical elements of a privacy camera may be co-designed with an algorithm (or program) configured to analyse privacy-preserving data. This is beneficial for achieving a privacy camera which on the one hand does not compromise on a person's privacy, but on the other hand still allows to extract particular scene information from privacy-preserving data captured by the privacy camera.

Exemplarily, privacy-preserving data captured by a privacy camera may not be sufficiently detailed for tasks such as person identification, or for extracting detailed information on a body of a person. A definition of “privacy-preserving data” depends on particular use cases (or scenarios) and related particular scene information and therefore may vary from case to case.

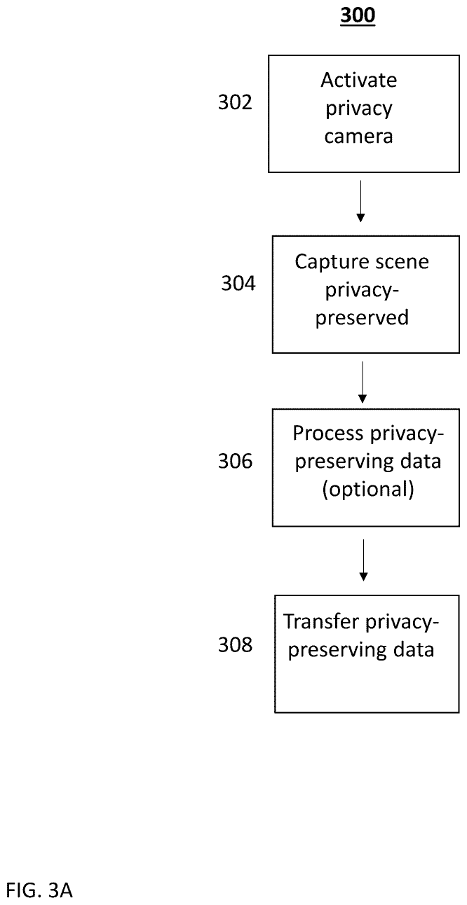

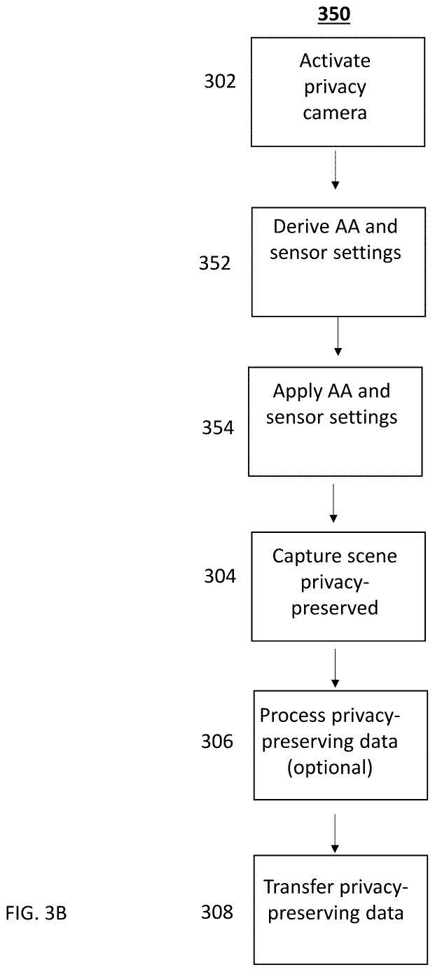

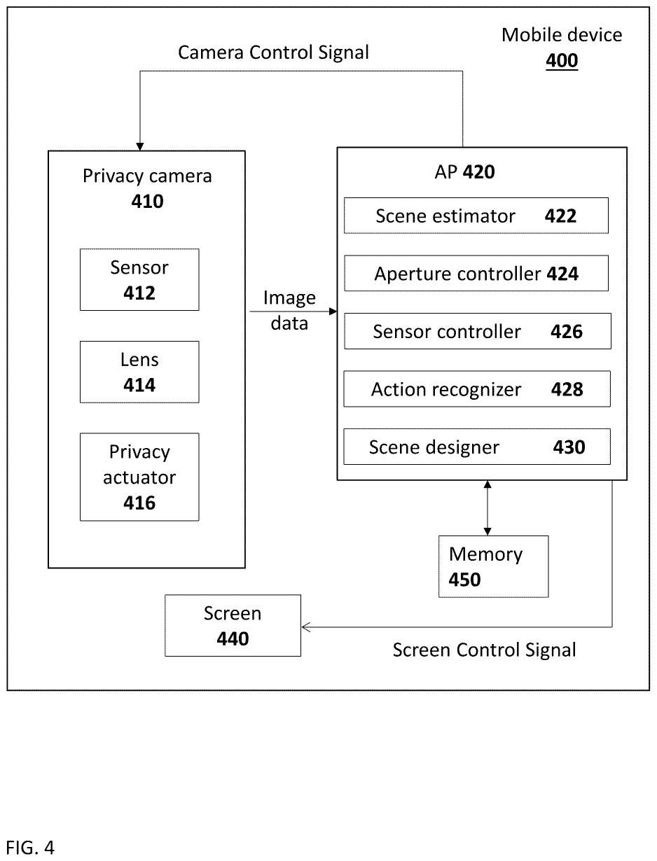

FIG. 3A shows an example of a method numbered 300 for generating and transferring privacy-preserving image data. A mobile device including a privacy camera such as mobile device 400 (FIG. 4) may be configured to perform method 300.
In step 302, a user or a program activates a privacy camera included in a mobile device.
In step 304, the camera captures privacy-preserving image data of a scene.
In an optional step 306, the privacy-preserving image data may be processed. As an example, the privacy-preserving image data may be analysed to extract information on gestures or actions performed in a scene.
In a step 308, the privacy-preserving image data is transferred to the Internet (e.g. to a cloud server), where in general it is shared with a third person or with a group of third persons. Note that by transferring privacy-preserving image data to the Internet, no potentially privacy-violating data is transferred. Therefore and desirably, the privacy of a person is preserved.

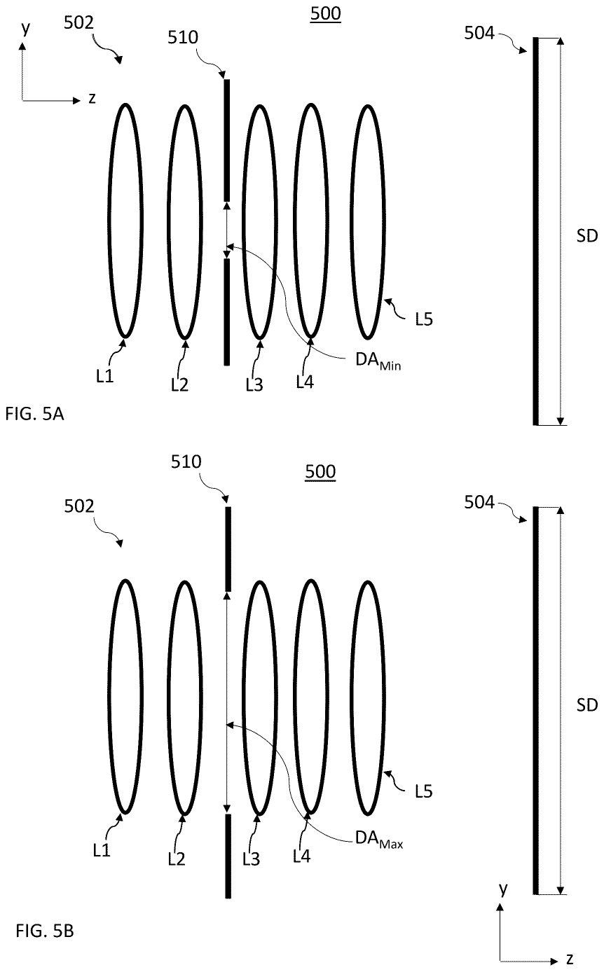

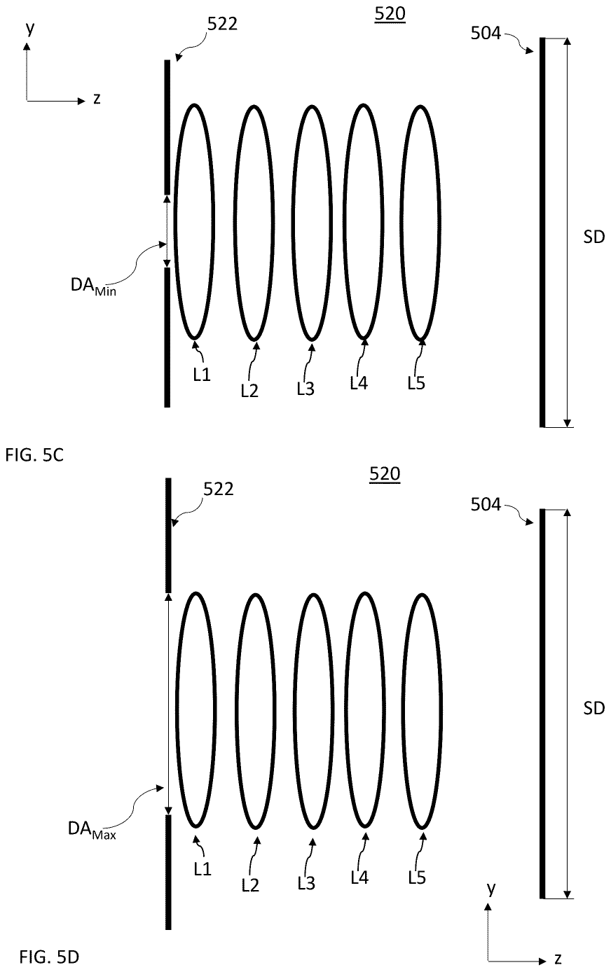

FIG. 3B shows another example of a method numbered 350 for generating and transferring privacy-preserving image data. A mobile device including a privacy camera having an adaptive aperture (“AA”) such as camera 500 (FIGS. 5A, 5B) may be configured to perform method 350. An AA changes a camera's f number (f/#) by opening or closing an aperture diameter (“DA”) of the camera. By changing a camera's f/#, the camera's depth of focus (“DoFo”) is changed according to DoFo=c·f/#, where c is a “circle of confusion” as known in the art. c does not change when changing the camera's f/#, so that DoFo~f/#. With respect to a camera that is defocused (or “out-of-focus”), we note that by increasing the camera's DoFo, the camera can be brought into focus. This without any further movements for focusing, e.g. without movements by the camera's lens or by the camera's image sensor. In the following example, we refer to P-O camera 154 in a collapsed state, as shown in FIG. 1D. In the collapsed state, P-O camera 154 is not operational to image a scene in high image resolution, as shown in FIG. 1E: imaged dot 166 is significantly blurred when compared to (real) dot 160. However, an amount of blurring can be adapted by changing the DoFo. In other words, when using an AA, an amount of blurring can be defined via a f/#of P-O camera 154. In particular, this means that the AA can be used to fulfil particular privacy-camera conditions. For example, a degree of privacy can be increased by opening the AA (decreasing f/#) and vice versa. The AA may be operational to change a f/# of P-O camera 154 discretely or continuously between a minimum f/# in the range of e.g. f/#_{Min}=1 to f/#_{Min}=5 (or simply “f/#_{Min}=f/1−f/5”) and a maximum f/# in the range of about f/#_{Max}=f/1.2−f/50. In a Wide camera example, f/#_{Min} may be in the range of f/1.5 to f/3 and f/#_{Max} may be in the range of f/2 to f/16. In a Tele camera example, f/#_{Min} may be in the range of f/1.8 to f/5 and f/#_{Max} may be in the range of f/2.5 to f/16.

As shown, method 350 includes all steps 302, 304, 306 and 308 of method 300. In addition, method 350 includes two additional steps 352 and 354. In the two additional steps, particular privacy-camera conditions of the camera are implemented.

In step 352, desired settings for an AA and (optional) an image sensor are derived. For this, image data of a scene is captured and analysed. In case a privacy camera such as P-O camera 154 is used, the analysis may for example assess a degree of blurring in the image data. In step 352, the privacy camera may be used with a relatively large f/#, corresponding to a relatively large DoFo. In case a regular camera is used, i.e. a camera which is not a privacy camera, the analysis may for example estimate (or “forecast”) a degree of blurring in image data as captured with a privacy camera. Based on the analysis of the image data, desired AA settings are derived.

It is noted that by changing f/#, an amount of light reaching an image sensor changes proportional to f/#². When increasing a camera's f/#from a minimum “f/#_{Min}” to a new “f/#_{New}”>f/#_{Min}, an amount of light entering the camera decreases proportionally to a factor (f/#_{New}/f/#_{Min})². Therefore, for harvesting a comparable amount of light in both scenarios, an exposure time of an image sensor may be modified accordingly. For example, with the camera in an AA state corresponding to f/#_{Min}, an exposure time T_{Exp} may be marked “T_{Exp-Min}”. To harvest a comparable amount of light with the camera in an AA state corresponding to f/#_{New}, a new exposure time “T_{Exp-New}” may be calculated by T_{Exp-New}=T_{Exp-Min} (f/#_{New}/f/#_{Min})². It is noted that when capturing a video stream of images (“video stream”), a maximum exposure time is limited by a frame rate used to capture the video stream. For example, when using a frame rate of 30 frame per second (“fps”), T_{Exp-New}<33 ms must be fulfilled. When using a frame rate of 60 frame per second (“fps”), T_{Exp-New}<16 ms must be fulfilled etc. In some examples, an image sensor operational to perform “pixel binning” as known in the art may be used. Pixel binning is a technique where multiple adjacent or “neighbouring” (smaller) pixels on an image sensor are combined (or “binned”, “grouped”, or “merged”) to work together as one (bigger) pixel. By pixel binning, the image sensor can be switched between at least two different pixel (or “spatial”) resolutions, a first higher pixel resolution where small pixel are individually captured and read out, and a second lower pixel resolution where multiple small pixel are combined to a bigger pixel which is captured and read out. It is noted that in the first pixel resolution, the areal size (or “area”) of a single pixel is smaller than in the second pixel resolution. The area reduction causes a reduction in terms of an amount of light that enters (or “is harvested by”) a single pixel, e.g. given by a number of photons that enter a pixel per unit time. In some examples and for compensating (or “mitigating”) the effect of a decreased amount of light entering the camera when increasing a camera's f/#, the image sensor may be switched from the first higher pixel resolution to the second lower pixel resolution.

In step 354, the desired settings for an AA and (optional) an image sensor are applied. For example, a particular f/# of the privacy camera is realized by changing the AA. After applying the desired AA settings, particular privacy-camera conditions are fulfilled. In other examples, a user may manually control the AA to define a desired degree of blurring, corresponding to a desired degree of privacy.

FIG. 4 shows a mobile device numbered 400 configured to perform methods for generating and transferring privacy-preserving image data. Mobile device 400 may be configured to perform method 300 or method 350 disclosed herein. Mobile device 400 includes a privacy camera 410 configured to capture privacy-preserving image data. Privacy camera 410 includes an image sensor 412, a lens 414 having a lens optical axis and (optionally) a privacy actuator 416. In some examples, privacy camera 410 may be a P-O camera in a collapsed state (FIGS. 1D-E). It is noted that a P-O camera can be a privacy camera 410 when in collapsed state, and it can be a regular camera (operational to capture high-resolution image data) when in P-O state. Privacy actuator 416 may be configured to switch the P-O camera from a collapsed (privacy-preserving) state and a P-O (regular) state. In some examples, privacy actuator 416 may be operational to bring privacy camera 410 into a particular privacy state, e.g. an intermediate state. In physical terms, the intermediate state may be positioned (or “located”) between the collapsed state and the P-O state. “Intermediate” means here that a first movement actuated by privacy actuator 416 to switch the privacy camera between the collapsed state and the privacy-preserving camera state is shorter than a second movement to switch the privacy camera between the collapsed state and the pop-out state. Therefore, in an intermediate state the pop-out camera protrudes less from a mobile device surface than in the second camera state.

In some P-O cameras, there may be a large number (even an infinite number) of such intermediate states. In other examples and as shown in FIGS. 5A-D, privacy actuator 416 may include an AA to change a f/#of privacy camera 410 so that particular privacy-camera conditions are fulfilled. In other examples, privacy camera 410 may be a privacy camera such as privacy camera 202 (FIGS. 2A-B) or privacy camera 252 (FIGS. 2C-D). In yet other examples, privacy camera 410 may be represented by a 2-state (or more generally, a multi-state) zoom camera, for example as disclosed in PCT/IB2020/051405. The multi-state zoom camera has a zoom lens with two or more zoom states and is configured to capture privacy-preserving image data by operating the zoom lens at a zoom lens position being between the two or more zoom states.

Mobile device 400 further includes an application processor (AP) 420. AP 420 includes a scene estimator 422, e.g. configured to perform basic scene understanding such as people detection or animal detection, an aperture controller 424, e.g. for deriving AA settings in step 352, a sensor controller 426, e.g. for deriving sensor settings in step 352, an action recognizer 428, e.g. configured to identify an action or a posture or a gesture of a person appearing in a privacy-preserving image, as well as a (optional) scene designer 430. Scene designer 430 may be operational to process any privacy-preserving image data in order to design (or to generate) an image that includes an essential, but not privacy-violating information on the scene. For example, and based on results or outputs from scene estimator 422 as well as from action recognizer 426, scene designer 430 may design an image not showing an actual person performing a particular action, but showing an avatar selected by the actual person performing the particular action. The avatar may be or may not be similar to the actual person. Mobile device 400 includes in addition a screen 440 (e.g. for displaying high-resolution and/or privacy-preserving image data) and a memory 450 (e.g. for storing an avatar of an actual person).

We note that the methods disclosed herein may be performed also by other electronic devices including a camera. The other electronic devices may e.g. be a laptop computer, or a camera-including monitor connected to a computer. In other examples, an electronic device connected to an external camera may be configured to perform methods disclosed herein.

FIG. 5A illustrates schematically a camera numbered 500 including an adaptive aperture (“AA”) mechanism for performing method 350 as disclosed herein. Camera 500 includes a lens 502 including an exemplary plurality of lens elements (here, 5) marked L1-L5 and having an EFL, an image sensor 504 having a full image sensor diagonal (“SD”) and an AA 510. As visible, AA 510 is located between two lens elements of lens 502. AA 510 changes camera 500's f/#by changing an aperture diameter (“DA”) to define a degree of privacy. AA 510 may be operational as a privacy actuator such as privacy actuator 416. Camera 500 is shown in a first camera state, where AA 510 is maximally closed, so that a minimal aperture diameter DA_{Min} is achieved. In the first camera state, a f/#is f/#_{Max}, which is given by f/#_{Max}=EFL/DA_{Min}. In the first camera state, f/#_{Max}=f/1.2−f/50 may be fulfilled. Image data captured in the first camera state provides a low (or small) degree of blurring, corresponding to a low degree of privacy.

FIG. 5B illustrates schematically camera 500 of FIG. 5A in a second camera state. AA 510 is maximally opened, so that a maximum aperture diameter DA_{Max}>DA_{Min} is achieved. In the second camera state, a f/#is f/#_{Min}, which is given by f/#_{Min}=EFL/DA_{Max}. In the second camera state, f/#_{Min}=f/1.0-f/5 may be fulfilled. Image data captured in the second camera state provides a high (or large) degree of blurring, corresponding to a high degree of privacy. AA 510 may be operational to change a f/#of camera 500 discretely or continuously between the first state and the second state. The second state provides a higher degree of privacy, which is desired. On the other hand, the first state enables performing methods such as method 350 in more detail, which may or may not be desired. It may be switched between the first state and the second state so that particular privacy-camera conditions are fulfilled.

FIG. 5C illustrates schematically another camera 520 including an AA mechanism with an AA 522 for performing method 350 as disclosed herein. As visible, AA 522 is located on an object side of lens 502. Camera 520 is shown in a first camera state having f/#_{Max}.

FIG. 5D illustrates schematically camera 520 of FIG. 5C in a second camera state. In the second camera state, camera 520 has a f/#_{Min}<f/#_{Max}.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

1. A mobile device, comprising:
a privacy camera configured and operational to capture privacy-preserving image data of a scene, wherein the privacy-preserving image data comprises low-resolution details of the scene,
wherein the privacy camera is a pop-out camera configured to operate in a collapsed state to capture the privacy-preserving image data,
wherein the mobile device is configured to transfer the captured privacy-preserving image data to a communication network,
wherein the privacy of a person present in the scene is not violated by transferring the privacy-preserving image data to the communication network,
wherein the non-violation of the privacy of the person present in the scene is associated with a non-transfer of unintentional high-resolution image data to the communication network.

2. The mobile device of claim 1, wherein the communication network is the Internet.

3. (canceled)

4. The mobile device of claim 1, wherein the mobile device has a rear surface and a front surface located opposite to the rear surface, wherein the front surface includes a screen, wherein the privacy camera is included in the rear surface and has a privacy-preserving camera state in which the pop-out camera protrudes less from the rear surface than in a non-privacy preserving camera state.

5. The mobile device of claim 1, wherein the privacy camera includes a privacy actuator, and wherein the privacy actuator is operational to switch the privacy camera between a privacy-preserving camera state and one or more additional non-privacy-preserving camera states.

6. The mobile device of claim 5, wherein the pop-out camera includes an optical component, wherein the one or more additional camera states include a collapsed state and a pop-out state, and wherein the privacy actuator is configured to move the optical component to switch the privacy camera between the privacy-preserving camera state, the collapsed state and a pop-out state.

7. The mobile device of claim 6, wherein a first movement of the optical component to switch the privacy camera between the collapsed state and the privacy-preserving camera state is shorter than a second movement of the optical component to switch the privacy camera between the collapsed state and the pop-out state.

8. The mobile device of claim 7, wherein the mobile device has a rear surface and a front surface located opposite to the rear surface, wherein the front surface includes a screen, wherein the privacy camera is included in the rear surface, and wherein in the privacy-preserving camera state, the pop-out camera protrudes less from the rear surface than in the pop-out state.

9. The mobile device of claim 5, wherein the privacy camera is a multi-state zoom camera having a zoom lens with two or more zoom states, wherein each zoom state corresponds to a respective zoom state lens position, and wherein the multi-state zoom camera operates as a privacy camera when not operated at a respective zoom state lens position.

10. The mobile device of claim 1, wherein the mobile device is configured to extract particular scene information from the privacy-preserving image data.

11. The mobile device of claim 10, wherein the particular scene information is an action or a gesture or a posture of a person.

12. The mobile device of claim 11, wherein the mobile device is further configured to create an avatar, and wherein the avatar is shown performing the action or the gesture or the posture of the person.

13. The mobile device of claim 1, wherein the privacy camera includes an adaptive aperture (AA), and wherein the AA is used to define a degree of privacy.

14. The mobile device of claim 13, wherein the pop-out camera has a f number f/#, wherein the f/# depends on the AA, and wherein a minimum f/#_{Min} is in the range of f/1.0-f/5.

15. The mobile device of claim 13, wherein the pop-out camera has a f number f/#, wherein the f/#depends on the AA, and wherein a maximum f/#_{Max} is in the range of f/1.2
f/50.

16. The mobile device of claim 13, wherein the pop-out camera is a Wide camera having a f number f/#, wherein the f/# depends on the AA, and wherein a minimum f/#_{Min} may be in the range of f/1.5 to f/3 and a maximum f/#_{Max} may be in the range of f/2 to f/16.

17. The mobile device of claim 13, wherein the pop-out camera is a Tele camera having a f number f/#, wherein the f/#depends on the AA, and wherein f/#_{Min} may be in the range of f/1.8 to f/5 and f/#_{Max} may be in the range of f/2.5 to f/16.

18. The mobile device of claim 13, wherein the AA is controlled by a user.

19. The mobile device of claim 13, wherein the AA is controlled by an algorithm.

20. The mobile device of claim 13, wherein the mobile device includes at least one additional camera, and wherein image data captured by the at least one additional camera is used to define the AA.

21. The mobile device of claim 1, wherein the privacy camera has an effective focal length in the range of 2.5 mm to 50 mm.

22. The mobile device of claim 21, wherein the privacy camera has an effective focal length in the range of 2.5 mm to 15 mm.

23. The mobile device of claim 1, wherein the mobile device is a smartphone.

24. The mobile device of claim 1, wherein the mobile device is a tablet.

25-41. (canceled)
